(19) United States
(12) Patent Application Publication
(10) Pub. No.: US 2006/0143920 A1
(43) Pub. Date: Jul. 6, 2006

(54) Anodized aluminum foil sheets and expanded aluminum foil (EAF) sheets and methods of making and using the same

(76) Inventors: Robert Morrison, Phoenix, AZ (US); Christopher Rouille, Tucson, AZ (US); Mary Stone Bowers, San Jose, CA (US)

Correspondence Address: WITHERS & KEYS, LLC, P. O. BOX 2049, MCDONOUGH, GA, 30253, US

(21) Appl. No.: 11/311,966

(22) Filed: Dec. 19, 2005

Related U.S. Application Data
(60) Provisional application No. 60/636,986, filed on Dec. 17, 2004.

(51) Int. Cl. B32B 15/20; B23P 15/16

(52) U.S. Cl. 29/896.6; 428/457; 428/340; 29/17.2; 29/17.3

(57) ABSTRACT

Anodized aluminum foil sheets and expanded aluminum foil (EAF) and composites containing the same are disclosed. Methods of making anodized aluminum foil sheets and expanded aluminum foil (EAF) and composites containing the same are also disclosed. Methods of using anodized aluminum foil sheets and expanded aluminum foil (EAF) and composites containing the same are further disclosed.

### CROSS-REFERENCE TO RELATED APPLICATIONS

This patent application claims the benefit of priority to U.S. provisional patent application Ser. No. 60/636,986 entitled “EXPANDED ALUMINUM FOIL (EAF) AND METHODS OF MAKING AND USING THE SAME”, filed on Dec. 17, 2004, the subject matter of which is hereby incorporated by reference in its entirety.

### FIELD OF THE INVENTION

The present invention is directed to anodized aluminum foil sheets and expanded aluminum foil (EAF) sheets and composites containing the same suitable for use as a lightning strike material. The present invention is further directed to methods of making and using anodized aluminum foil sheets and expanded aluminum foil (EAF) and composites containing the same.

### BACKGROUND OF THE INVENTION

Aluminum foil sheets and expanded aluminum foil (EAF) sheets and composites containing the same have been used to form aircraft components for some time. Typically, sheets of aluminum foil are modified in batch processes to improve the adhesion on the aluminum sheet to other components such as an adhesive resin layer. One process step that is used to improve the adherence of aluminum sheets to other materials is an anodization step, wherein exposure of the aluminum sheet to an acid, such as phosphoric acid, results in an oxide coating over the outer surfaces of the aluminum sheet. Exemplary anodization steps are disclosed in U.S. Pat. Nos. 4,085,012 and 4,793,903, the subject matter of which is hereby incorporated by reference in its entirety.

Known commercially used anodization steps, such as those disclosed in the above-referenced U.S. patents, involve batch processes. In these processes, one or more aluminum sheets are cut into a particular shape having fixed dimensions. For example, an aluminum sheet may be cut into a rectangular sheet having a width of 1.22 meters (m) (4 feet (ft)) and a length of 1.83 m (6 ft). Each sheet is anodized one sheet at a time. Such batch processes require substantial time and cost when large numbers of aluminum sheets need to be anodized.

The above-referenced batch processes produce anodized aluminum sheets having a complex surface structure, which includes “spire” structures formed in an aluminum oxide film on the surface of the aluminum sheet. The “spire” structures of the aluminum oxide film create a non-uniform film thickness having increased surface area, which enables improved adhesion of the aluminum sheet to other materials. As disclosed in U.S. Pat. No. 4,085,012, the aluminum oxide film has a varying film thickness ranging from 500 to 6000 Angstroms with pores having a pore diameter of 300 to 600 Angstroms and pore depths of about 400 to 5500 Angstroms. See, U.S. Pat. No. 4,085,012, column 4, lines 20-23.

A more complete description of the spire-containing surface structure may be found in the article, “Production of an Adhesive Substrate Using Phosphoric Acid and a Continuous Coil Operation” by Marczak et al. (hereinafter, “Marczak et al.”). As shown in FIG. 1 of Marczak et al., spire formation and development proceeds over time during a given anodization step resulting in a desirable spire-containing surface structure.

Marczak et al. also discloses a continuous anodization process for aluminum sheets. In this disclosed process, continuous sheets of aluminum are anodized using a relatively high electrical current (compared to batch processes) to produce the desirable spire structure as described in the batch processes disclosed in U.S. Pat. Nos. 4,085,012 and 4,793,903.

Efforts continue in an attempt to improve known anodization processes. As disclosed in Marczak et al., continuous anodization processes are desirable in order to cost effectively produce a high volume of anodized aluminum sheet material. However, known continuous anodization processes, including the process disclosed in Marczak et al., have a number of process limitations and/or parameters that prevent processing of some aluminum sheet material. For example, aluminum sheets having a sheet thickness of less than about 101.6 microns (μ) (4 mil (0.004 inch)) and expanded aluminum sheets having perforations therein are not currently run on known continuous anodization process equipment.

Further efforts are needed to expand the process capabilities of known continuous anodization processes. In addition, other processing steps need to be reevaluated in an attempt to enhance the adhesion of anodized aluminum sheets to other materials such as an adhesive resin layer.

There is a need in the art for continuous anodization processes capable of processing aluminum sheets having a sheet thickness of less than 152.4μ (6 mil (0.006 inch)) and/or perforations within the sheet material. Further, there is a need in the art for continuous anodization processes that enhance the adherence of anodized aluminum sheets to other materials such as an adhesive resin layer.

### SUMMARY OF THE INVENTION

The present invention addresses some of the needs in the art discussed above by the discovery of a continuous anodization process capable of processing aluminum sheets having a sheet thickness of less than 152.4μ (6 mil (0.006 inch)) and/or perforations within the sheet material. The continuous anodization process of the present invention results in rolls of anodized aluminum sheet material having a surface structure substantially different from the spire-containing surface structure of known anodized aluminum sheets. The resulting rolls of anodized aluminum sheet material may be used to form composite structures containing one or more anodized aluminum sheet in combination with one or more composite materials, such as a polymeric film layer, and a glass fabric layer.

Accordingly, the present invention is directed to continuous anodization processes. In one exemplary embodiment of the present invention, the continuous anodization process comprises a process for forming an expanded aluminum foil sheet material, wherein the process comprises continuously feeding a sheet of expanded aluminum foil into an anodizing bath, wherein the sheet has a final sheet width of up to about 1.83 m (6 ft) and a final length of greater than 2.44 m (8 ft); and anodizing the sheet to form an anodized sheet of expanded aluminum foil. The process may further comprise a number of additional steps including, but not limited to, an alkaline wash step, a deoxidizing step, one or more rinse steps, a drying step, a primer application step, and a primer curing step.

In a further exemplary embodiment of the present invention, the continuous anodization process comprises a process for forming an anodized aluminum foil sheet material, wherein the process comprises continuously feeding a sheet of aluminum foil into an anodizing bath, wherein the sheet has a final sheet width of up to about 1.83 m (6 ft) and a final length of greater than 2.44 m (8 ft), the sheet having a sheet thickness of less than about 101.6μ (0.004 inch (4 mil)); and anodizing the sheet to form an anodized sheet of aluminum foil; wherein the sheet is exposed to a maximum tension of up to about 19.61 kg/m² (2 psi), a maximum electrical current of up to about 800 amps/m², a maximum anodizing temperature of up to about 107° C. (225° F.), and a maximum line speed of about 4.57 meters per minute (mpm) (15 feet per minute (fpm)) during the process. In this exemplary process, anodized sheets of aluminum foil or expanded aluminum foil having a sheet thickness of from about 38.1μ (0.0015 inch (1.5 mil)) to about 50.8μ (0.002 inch (2 mil)) may be produced.

In yet a further exemplary embodiment of the present invention, the continuous anodization process comprises a process for forming an anodized aluminum foil sheet material, wherein the process comprises (a) unwinding a sheet of expanded aluminum foil from a continuous roll of expanded aluminum foil having a roll length of up to or greater than 1524 m (5000 ft); (b) maintaining a line tension of less than about 19.61 kg/m² (2 psi) and a line speed of up to about 4.57 mpm (15 fpm); (c) washing the sheet of expanded aluminum foil with an alkaline solution; (d) rinsing the sheet of expanded aluminum foil with deionized water after the wash step; (e) passing the sheet of expanded aluminum foil through a phosphoric acid anodizing bath having bath parameters as follows to form an anodized sheet: (i) a H⁺ concentration ranging from about 100 to about 250 g/L, (ii) a dwell time ranging from about 30 seconds to about 5 minutes, (iii) a bath temperature ranging from about 80 to about 140° C., (iv) an electrical current ranging from about 600 to about 900 amp/m², (v) a voltage ranging from about 2 to about 60 volts, and (vi) an amount of dissolved Al of less than about 9000 ppm; (f) drying the anodized sheet at a drying temperature of less than about 93° C. (200° F.); (g) applying a primer coating to the dried anodized sheet at a primer coating weight of about 0.65 g/m² (60 mg/ft²) to about 1.08 g/m² (100 mg/ft²) of primer on each side of the dried anodized sheet; (h) curing the primer coating at a cure temperature of less than about 177° C. (350° F.); and (i) taking up the primed, anodized sheet of expanded aluminum foil while maintaining a line tension of less than about 19.61 kg/m² (2 psi).

The present invention is also directed to anodized expanded aluminum foil sheet materials. In one exemplary embodiment of the present invention, the anodized sheet of expanded aluminum foil has a final sheet width of up to about 1.83 m (6 ft) and a final sheet length of greater than about 2.44 m (8 ft). The anodized sheets of expanded aluminum foil may have a sheet thickness of less than or equal to about 152.4μ (0.006 inch (6 mil)), and in some desired embodiments, have a sheet thickness of about 50.8μ (0.002 inch (2 mil)) or less. The anodized expanded aluminum foil may be formed into rolls having a roll length of up to and greater than about 1524 m (5000 ft).

The present invention is further directed to composite structures containing one or more layers of the above-described anodized expanded aluminum foil. In one desired embodiment of the present invention, the composite structure comprises an anodized expanded aluminum foil sandwiched between a resin film layer and a glass fabric layer.

Composite structures of the present invention may be used in a variety of application. In one desired embodiment, composite structures of the present invention are used as a lightning strike material, forming an outer surface of an aircraft.

These and other features and advantages of the present invention will become apparent after a review of the following detailed description of the disclosed embodiments and the appended claims.

### BRIEF DESCRIPTION OF THE FIGURES

FIGS. 1A-1B depicts an exemplary process flow diagram for an exemplary continuous anodization process of the present invention;

FIG. 2 depicts an exemplary apparatus for use in the continuous anodization process of the present invention;

FIG. 3 depicts an exemplary composite structure containing an expanded aluminum foil of the present invention;

FIG. 4 depicts another exemplary complex composite structure containing an expanded aluminum foil of the present invention;

FIG. 5A depicts an exemplary apparatus for performing a lightning strike test on a composite structure of the present invention; and

FIG. 5B depicts a cross-sectional view of the exemplary apparatus of FIG. 5A as shown along line A-A in FIG. 5A.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to a continuous anodization process for forming expanded aluminum foil sheet material. The present invention is further directed to expanded aluminum foil sheet material, as well as, methods of using the expanded aluminum foil sheet material to form composite structures. The present invention is even further directed to composite structures comprising at least one layer of expanded aluminum foil sheet material.

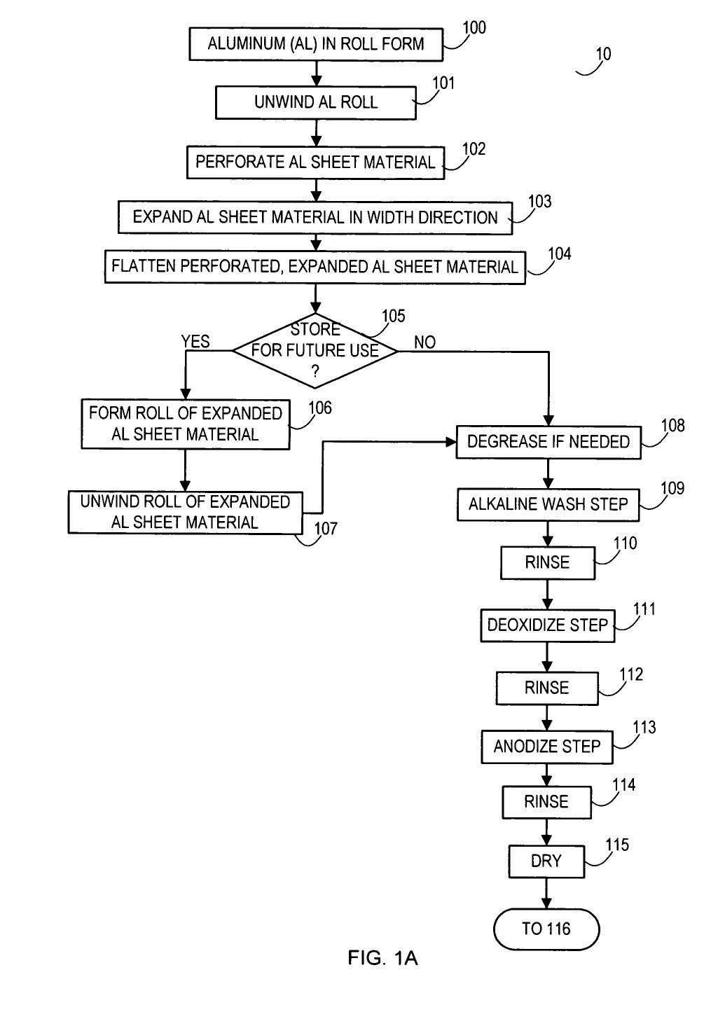

The continuous anodization process of the present invention comprises a number of process steps and variables. An exemplary process flow diagram for an exemplary continuous anodization process of the present invention is shown in FIGS. 1A-1B. As shown in FIG. 1A, exemplary process 10 begins at step 100, wherein a roll of aluminum is provided. In step 101, the roll of aluminum is unwound and fed into an apparatus. The aluminum sheet material is perforated in step 102, and expanded from a first width to a second width (i.e., typically less than the first width) in step 103. In step 104, the expanded, perforated aluminum sheet material is flattened.

At decision block 105, the flattened aluminum sheet material is either stored for future use or proceeds to further process steps. If a decision is made to store the flattened aluminum sheet material, exemplary process 10 proceeds to step 106, where the flattened aluminum sheet material is taken up on a winder to form a roll of the flattened aluminum sheet material. The roll of the flattened aluminum sheet material may be unwound in step 107 when desired, and proceeds to an optional degreasing step in step 108.

If a decision is made at decision block 105 to proceed without storage of the flattened aluminum sheet material, exemplary process 10 proceeds directly to optional degreasing step 108. From step 108, exemplary process 10 proceeds to an alkaline wash step 109, and then to a rinse step 110. In step 111, the washed aluminum sheet material is deoxidized, and subsequently rinsed in step 112. After deoxidizing and rinsing, the deoxidized aluminum sheet material proceeds to an anodizing step 113. After anodization, the anodized aluminum sheet material is rinsed in rinse step 114, and then dried in drying step 115. From step 115, exemplary process 10 proceeds to decision block 116 in FIG. 1B.

At decision block 116, the anodized aluminum sheet material is either stored for future use or proceeds to further process steps. If a decision is made to store the anodized aluminum sheet material, exemplary process 10 proceeds to step 117, where a protective liner is brought into contact with the anodized aluminum sheet material. In step 118, the anodized aluminum sheet material/protective liner combination is taken up on a winder to form a roll of the anodized aluminum sheet material/protective liner combination. The roll of the anodized aluminum sheet material/protective liner combination may be unwound in step 119 when desired, and proceeds to a primer application step 120.

If a decision is made at decision block 116 to proceed without storage of the anodized aluminum sheet material, exemplary process 10 proceeds directly to the primer application step 120. From step 120, exemplary process 10 proceeds to a primer curing step 121. After curing of the primer layer, exemplary process 10 proceeds to decision block 122, where a decision is made to store the primed anodized aluminum sheet material for future use.

If a decision is made to store the primed anodized aluminum sheet material, exemplary process 10 proceeds to step 123, where a protective liner is brought into contact with the primed anodized aluminum sheet material. In step 124, the primed anodized aluminum sheet material/protective liner combination is taken up on a winder to form a roll of the anodized aluminum sheet material/protective liner combination. The roll of the primed anodized aluminum sheet material/protective liner combination may be unwound in step 125 when desired, and proceeds to an adhesive application step 126. From step 126, exemplary process 10 proceeds to decision block 127.

At decision block 127, the adhesive coated anodized aluminum sheet material is either stored for future use or proceeds to further process steps. If a decision is made to store the adhesive coated anodized aluminum sheet material, exemplary process 10 proceeds to step 128, where a protective release liner is brought into contact with the adhesive layer of the anodized aluminum sheet material. In step 129, the anodized aluminum sheet material/protective release liner combination is taken up on a winder to form a roll of the anodized aluminum sheet material/protective release liner combination. The roll of the anodized aluminum sheet material/protective release liner combination may be unwound in step 130 when desired, and proceeds to a lamination step 131.

If a decision is made at decision block 127 to proceed without storage of the adhesive coated anodized aluminum sheet material, exemplary process 10 proceeds directly to the lamination step 131. From lamination step 131, exemplary process 10 proceeds to a roll take-up step 132, where the composite containing an anodized aluminum sheet layer is wound into a roll of composite material, and stored for future use.

As shown in exemplary process 10, the continuous anodization process of the present invention may contain a variety of process steps. A detailed description of one or more steps of the continuous anodization process of the present invention is given below.

I. The Continuous Anodization Process

The continuous anodization process of the present invention may be described by one or more process steps. A description of various process steps is provided below.

A. Exemplary Process Steps

The continuous anodization process of the present invention typically comprises one or more of the following exemplary steps.

1. Alkaline Wash Step

The continuous anodization process of the present invention typically comprises an alkaline wash step such as exemplary alkaline wash step 109 of exemplary process 10 shown in FIG. 1A. The alkaline wash step takes place prior to anodizing the aluminum sheet material. In the alkaline wash step, the continuously fed aluminum sheet is subjected to an alkaline spray at a desired spray pressure. The alkaline wash step cleans the outer surfaces of the aluminum sheet.

A variety of alkaline solutions may be used in the present invention. Suitable alkaline solutions include, but are not limited to, alkaline cleaning solutions containing potassium hydroxide, potassium silicate, sodium sesquicarbonate, sodium tripolyphosphate, nonyl phenoxy polyethoxy ethanol, and combinations thereof. Suitable commercially available alkaline cleaning solutions that may be used in the present invention include, but are not limited to, alkaline cleaning solutions commercially available from Brent America Inc. (La Mirada, Calif.) under the trade designations ARDROX and PYRENE, such as PYRENE US 152.

In the continuous anodization process of the present invention, the alkaline cleaning solution is applied to the continuously fed aluminum sheet via any known application. Typically, the alkaline cleaning solution is applied via a spraying step, wherein the alkaline cleaning solution is applied at a relatively low spray pressure when compared to spray pressure typically used in a solid (i.e., no perforations) foil anodizing processing.

In one desired embodiment of the present invention, an expanded aluminum sheet is continuously fed through an alkaline spray solution, wherein the spray solution comprises an alkaline solution comprising about 118 milliliters (ml) to about 237 ml (i.e., about 4 to about 8 oz) of PYRENE US 152 alkaline cleaning solution per 4.55 liters (1.0 gallon) of water using a relatively low spray pressure.

2. Deoxidizing Step

The continuous anodization process of the present invention may further comprise a deoxidizing step such as exemplary deoxidizing step 111 of exemplary process 10 shown in FIG. 1A. When used in the continuous anodization process, the continuously fed aluminum sheet is exposed to an etchant such as sulfuric acid, nitric acid, or a combination thereof. Suitable commercially available etchants include, but are not limited to, etchants available from Henkel Surface Technologies (Madison Heights, Mich.) under the trade designation DEOXALUME®, such as DEOXALUME® 2310.

The deoxiding step is used to remove any surface oxides, smut or other surface contaminants present on the aluminum sheet prior to an alkaline wash step or resulting from an alkaline wash step or both. When present, the continuously fed aluminum sheet is typically exposed to an etchant solution for up to about 40 seconds. In one exemplary embodiment of the present invention, an expanded aluminum sheet is continuously fed through an etchant solution, wherein the etchant solution comprises sulfuric acid, and the deoxidizing dwell time in the etchant solution ranges from about 20 seconds to about 40 seconds.

In one desired embodiment of the present invention, the continuous anodization process of the present invention does not comprise an deoxiding step. Instead, the continuously fed aluminum sheet proceeds from an alkaline wash step to a rinse step and then directly to an anodizing step as described below.

3. Anodizing Step

The continuous anodization process of the present invention comprises an anodizing step such as exemplary anodizing step 113 of exemplary process 10 shown in FIG. 1A. In the anodizing step, the continuously fed aluminum sheet is subjected to an anodizing solution containing an acidic component. Suitable anodizing solutions include, but are not limited to, sulfuric acid solutions, and phosphoric acid solutions. Desirably, the anodizing solution comprises a phosphoric acid solution. Suitable commercially available materials that may be used to form anodizing solutions include, but are not limited to, phosphoric acid commercially available from Ashland Chemical (Columbus, Ohio).

In the anodizing step, the continuously fed aluminum sheet passes through an anodizing bath containing one or more acid components, and having an electrical current passing through the anodizing bath. Any portion of the aluminum sheet spends a desired amount of time (referred to herein as “anodizing dwell time”) in the anodizing bath.

The anodizing step results in the formation of an aluminum oxide coating on outer surfaces of the aluminum sheet material. The surface structure and thickness of the aluminum oxide coating may be controlled by a number of process variables including, but not limited to, the acid concentration of the anodizing bath, the dwell time in the anodizing bath, the temperature of the anodizing bath, pre-treatment of the aluminum sheet material, and the type of aluminum sheet material used.

A number of process variables and exemplary process parameters that may be used in the continuous anodization processes of the present invention are shown in Table 1 below.

TABLE 1
Exemplary Anodizing Step Variables and Process Parameters

| Process | Exemplary Process | Desired Process |
|---|---|---|
| Variable | Variable Parameters | Variable Parameters |
| acid type | sulphuric acid, | phosphoric acid |
| | phosphoric acid | |
| H⁺ concentration | 100 to 250 g/L | 180 to 210 g/L |
| dwell time | 30 seconds to | 30 seconds to |
| | 5 minutes | 2 minutes |
| bath temperature | ˜80 to ˜140° C. | ˜104° C. to ˜107° C. |
| electrical current | ˜600 to ˜900 amp/m² | ˜700 to ˜800 amp/m² |
| voltage | ˜2 to ˜60 volts | ˜10 to ˜40 volts |
| dissolved Al | <9000 ppm | <7000 ppm |

In one desired embodiment of the present invention, an expanded aluminum sheet is continuously fed through an anodizing bath of phosphoric acid having an H⁺ concentration of about 180 to 210 g/L and a bath temperature of about 104° C. to about 107° C. The expanded aluminum sheet is desirably exposed to an electrical current ranging from about 700 to about 800 amp/m² at a voltage ranging from about 10 to 40 volts for a dwell time of about 120 seconds.

The resulting anodized aluminum sheet has an aluminum oxide coating on each side of the aluminum sheet. Typically, the resulting anodized aluminum sheet has an aluminum oxide coating on each side of the aluminum sheet, wherein each aluminum oxide coating (i.e., the coating on each side) has a coating weight ranging from about 0.5 grams per square meter (g/m²) to about 2.0 g/m².

4. Rinse Steps

The continuous anodization process of the present invention may comprise one or more rinse steps such as rinse steps 110, 112, and 114 of exemplary process 10 shown in FIG. 1A. In each rinse step, the continuously fed aluminum sheet passes through a rinse bath or a rinse spray. Typically, the rinse comprises deionized water.

In one desired embodiment of the present invention, the post acid rinse step (i.e., rinse step 114 shown in FIG. 1A) comprises subjecting the continuously fed aluminum sheet to a spray rinse at a minimal rinse spray pressure

The process of the present invention may include one or more of the above-described anodizing steps, each of which is followed by a separate post acid rinse step as described above. In one desired embodiment of the present invention, the process comprises two separate anodizing steps, each of which is followed by a separate post acid rinse step.

5. Drying Step

The continuous anodization process of the present invention may further comprise one or more drying steps such as drying step 115 of exemplary process 10 shown in FIG. 1A. In each drying step, the continuously fed aluminum sheet passes through an oven having a relatively low oven temperature for a desired period of time (referred to herein as “oven dwell time”).

Any conventional oven may be used in the present invention. Suitable ovens include, but are not limited to, an infrared (IR) oven, a convection oven, and an indirect fire oven. Desirably, the oven comprises an IR oven.

In the continuous anodization process of the present invention, drying of the continuously fed aluminum sheet takes place in an oven having an oven temperature of up to about 93° C. (200° F.). Desirably, the oven temperature ranges from about 93° C. to about 149° C., more desirably, from about 93° C. to about 121° C.

6. Primer Application Step

The continuous anodization process of the present invention may further comprise a primer application step such as exemplary primer application step 120 of exemplary process 10 shown in FIG. 1B. The primer application step takes place after anodizing the aluminum sheet material. In the primer application step, the continuously fed aluminum sheet is coated with a primer composition, such as a curable resin. The primer coating is subsequently cured to form a tie layer between the aluminum oxide coating formed ion the above-described anodizing step and a subsequently applied adhesive layer.

A variety of primer compositions may be used in the present invention. Suitable primer compositions include, but are not limited to, phenolic resins, substituted phenolic resins, epoxy resins, and combinations thereof. Suitable commercially available materials that may be used to form primer compositions include, but are not limited to, phenolic resin primer compositions commercially available from Durez Corporation (Addison, Tex.) under the trade designation VARCUM, such as VARCUM 94917.

The primer composition may be applied to the anodized aluminum sheet using any known coating method. Suitable coating methods include, but are not limited to, solution coating, and Meyer rod coating applications. Desirably, the primer composition is applied using a no. 6 Meyer rod to apply a coating weight ranging from about 0.32 grams per square meter (g/m²) (30 mg/ft²) to about 1.51 g/m² (140 mg/ft²) of primer on each side of the anodized aluminum sheet. More desirably, the primer composition is applied at a coating weight ranging from about 0.65 g/m² (60 mg/ft²) to about 1.08 g/m² (100 mg/ft²) of anodized aluminum sheet on each side of the anodized aluminum sheet.

In the continuous anodization process of the present invention, the continuously fed anodized aluminum sheet is desirably solution coated with a primer composition commercially available from Durez Corporation (Addison, Tex.) under the trade designation VARCUM 94917, diluted to have a solids content of about 4.5 percent by weight.

7. Primer Curing Step

If the continuous anodization process of the present invention comprises a primer application step, the process also comprises a primer curing step such as primer curing step 121 of exemplary process 10 shown in FIG. 1B. In the primer curing step, the primer coated aluminum sheet passes through a curing oven having a relatively low oven curing temperature for a desired period of time (referred to herein as “cure time”).

In the continuous anodization process of the present invention, curing of the primer coated aluminum sheet takes place in a curing oven having an oven curing temperature of up to about 160° C. (320° F.). Desirably, the oven curing temperature ranges from about 121° C. (250° F.) to about 177° C. (350° F.), more desirably, from about 135° C. (275° F.) to about 160° C. (320° F.).

In one desired embodiment of the present invention, a primer coated aluminum sheet is continuously fed through a curing oven having multiple zones, wherein the first zone has a curing temperature of about 121° C. (250° F.) and the second zone has a curing temperature of about 177° C. (350° F.) with a total cure time ranging from about 240 seconds to about 360 seconds, more desirably, from about 280 seconds to about 320 seconds.

8. Bonding/Laminating Steps

As shown in FIG. 1B, the above-described exemplary continuous anodization process may comprise one or more steps wherein one or more layers of material are joined to the primed, anodized expanded aluminum sheet material. As shown in exemplary steps 126 and 131 of exemplary process 10, an adhesive layer and one or more additional sheet materials may be applied to and/or bonded to the primed, anodized expanded aluminum sheet material prior to or after a roll take-up step. It should be noted that in other embodiments of the present invention, instead of an adhesive layer, the continuous anodization process may involve applying one or more additional layers (i.e., layer(s) other than an adhesive layer or in combination with an adhesive layer) to the primed, anodized expanded aluminum sheet material. The one or more additional layers may be bonded to the primed, anodized expanded aluminum sheet material via contact, heat, pressure or a combination thereof. For example, a fiber-reinforced prepreg may be brought into contact with and bonded to the primed, anodized expanded aluminum sheet material with or without heat, pressure, or a combination thereof.

As discussed below, a variety of layers of material may be combined with the primed, anodized expanded aluminum sheet material to form multi-layer composite sheet material in roll form. The resulting multi-layer composite sheets may be stored for future use or further processed by unwinding the roll of composite sheet material and subjecting the composite sheet material to one or more additional process steps. Suitable additional process steps may include, but are not limited to, cutting the composite sheet material, shaping (e.g., molding, stamping, etc.) the composite sheet material, laminating one or more additional layers to the composite sheet material, and joining the composite sheet material to a structure (e.g., a component of an aircraft or automobile).

B. Process Parameters

The continuous anodization process of the present invention may also be described by one or more process parameters including, but not limited to, the process parameters provided below.

1. Line Tension

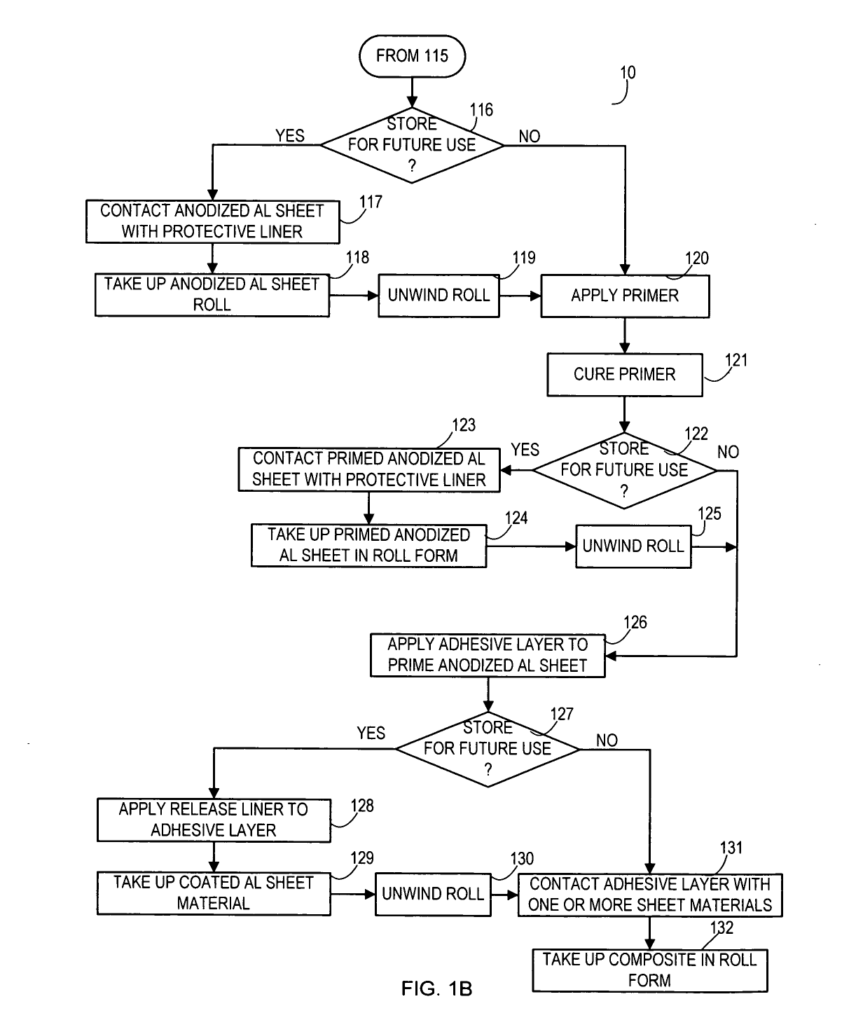

The continuous anodization process of the present invention continuously feeds aluminum sheet material through an apparatus such as exemplary apparatus 20 shown in FIG. 2. As shown in FIG. 2, exemplary apparatus 20 comprises material unwind station 201 where rolls 220 of aluminum sheet material or expanded aluminum sheet material 221 are fed into exemplary apparatus 20. Aluminum sheet material 221 proceeds to accumulator 202, and then to alkaline wash station 203.

One or more drive rolls may be used to move aluminum sheet material 221 through the continuous anodization process. Exemplary apparatus 20 comprises two drive rolls, drive roll 205 and drive roll 213. In exemplary apparatus 20, drive roll 205 is positioned between alkaline wash station 203 and phosphoric acid tank 207, while drive roll 213 is positioned after primer cure oven 211.

Aluminum sheet material 221 passes through drive roll 205 and proceeds to phosphoric acid tank 207. From phosphoric acid tank 207, aluminum sheet material 221 proceeds through post acid rinse 208, and then oven 209 to dry anodized aluminum sheet material 222. A primer coating is applied to anodized aluminum sheet material 222 at primer applicator 210, and is subsequently cured in curing oven 211.

Primed aluminum sheet material 223 proceeds through drive roll 213 to material rewind station 215, where rolls 228 of primed aluminum sheet material 223 are produced and removed from exemplary apparatus 20 for storage and/or further processing.

The one or more drive rolls used to move aluminum sheet material through the anodizing apparatus, such as exemplary apparatus 20, provide sufficient tension on the aluminum sheet material to move the aluminum sheet material through the apparatus. Care must be taken when determining the amount of tension to apply in order to prevent shrinkage and/or tearing of the aluminum sheet material or expanded aluminum sheet material in the width direction of the aluminum sheet material.

In the continuous anodization process of the present invention, the one or more drive rolls desirably applied less than about 19.61 kg/m² (2 psi) of force on the aluminum sheet material in order to move the aluminum sheet material through the anodizing apparatus. In one desired embodiment of the present invention, the one or more drive rolls apply from about 9.81 kg/m² (1 psi) to about 29.42 kg/m² (3 psi) of force on the aluminum sheet material in order to move the aluminum sheet material through the anodizing apparatus.

2. Line Speed

In the continuous anodization process of the present invention, the one or more drive rolls also provide a desired line speed through an anodizing apparatus. Desirably, aluminum sheet material moves through the anodizing apparatus at a line speed of at least about 1.52 mpm (5 fpm). In one desired embodiment of the present invention, aluminum sheet material moves through the anodizing apparatus at a line speed ranging from about 1.52 mpm (5 fpm) to about 6.10 mpm (20 fpm), more desirably, from about 3.05 mpm (10 fpm) to about 4.57 mpm (15 fpm), and even more desirably, about 4.57 mpm (15 fpm).

II. Anodized Aluminum Foil Sheet Material

The present invention is also directed to anodized aluminum foil sheet materials, and especially, anodized expanded aluminum foil sheet materials. In one exemplary embodiment of the present invention, the anodized sheet of aluminum foil or expanded aluminum foil has a final sheet width of up to about 3.66 m (12 ft) and a final sheet length of greater than about 2.44 m (8 ft). Typically, the anodized sheet of aluminum foil or expanded aluminum foil has a final sheet width ranging from about 0.91 m (3 ft) to about 3.05 m (10 ft), more typically, from about 1.22 m (4 ft) to about 1.83 m (6 ft). Further, the anodized sheet of aluminum foil or expanded aluminum foil typically has a final sheet length ranging from about 304.8 m (1000 ft) to about 1524 m (5000 ft), more typically, from about 609.6 m (2000 ft) to about 1219.2 m (4000 ft).

The above-described continuous anodization process of the present invention may be used to produce anodized sheets of aluminum foil or expanded aluminum foil having any desired sheet thickness. The continuous anodization process of the present invention is particularly useful for producing anodized sheets of aluminum foil or expanded aluminum foil having a sheet thickness of less than or equal to about 152.4μ (0.006 inch (6 mil)). In one desired embodiment of the present invention, the continuous anodization process is used to produce anodized sheets of aluminum foil or expanded aluminum foil having a sheet thickness of from about 38.1μ (0.0015 inch (1.5 mil)) to about 50.8μ (0.002 inch (2 mil)).

A variety of aluminum sheet materials may be used in the present invention. Suitable aluminum sheet materials include, but are not limited to, continuous web expanded aluminum foil formed from aluminum foil sheets having an original foil thickness (i.e., prior to expanding) ranging from about 25.4μ (0.001 inches) to about 152.4μ (0.006 inches). Suitable commercially available aluminum sheet materials that may be used in the present invention include, but are not limited to, aluminum sheet material commercially available from Dexmet Corporation (Naugatuck, Conn.) under the trade designation MICROGRID.

Suitable continuous web expanded aluminum foil used in the present invention may comprise any number of perforations within a given area of aluminum foil. Further, individual perforations may have any desired size, dimensions, and shape. Typically, the perforations are present as a uniform pattern of perforations along the continuous web expanded aluminum foil; however, non-uniform patterns of perforations may also be used in the present invention. Exemplary perforations have a diamond shape (or any other shape) and have a largest dimension (i.e., the longest distance from a point on a perforation to another point on the same perforation) of up to about 2.5 cm, typically, less than about 1.0 cm.

In one exemplary embodiment of the present invention, expanded anodized aluminum sheet material is formed by a continuous anodization process, wherein the process comprises the steps of:

(1) unwinding a sheet of expanded aluminum foil from a continuous roll of expanded aluminum foil having a roll length of up to or greater than 1524 m (5000 ft);

(2) maintaining a line tension of about 9.81 kg/m² (1 psi) to 19.61 kg/m² (2 psi) and a line speed of up to about 4.57 mpm (15 fpm);

(3) washing the sheet of expanded aluminum foil with an alkaline solution;

(4) rinsing the sheet of expanded aluminum foil with deionized water;

(5) passing the sheet of expanded aluminum foil through a phosphoric acid anodizing bath using the “Desired Process Variable Parameters” shown in Table 1 above;

(6) drying the anodized sheet at a drying temperature of less than about 93° C. (200° F.);

(7) applying a primer (i.e., desirably, VARCUM 94917 at a solids content of about 4.5 percent by weight) to the dried anodized sheet of expanded aluminum foil at a coating weight of about 0.65 g/m² (60 mg/ft²) to about 1.08 g/m² (100 mg/ft²) on each side of the dried anodized sheet of expanded aluminum foil;

(8) curing the primer coating at a cure temperature of less than about 177° C. (350° F.); and

(9) taking up the primed, anodized sheet of expanded aluminum foil while maintaining a line tension of about 9.81 kg/m² (I psi) to about 19.61 kg/m² (2 psi).

III. Composite Materials Containing an Expanded Aluminum Foil Sheet Material

The present invention is further directed to composite structures containing at least one layer of anodized aluminum foil layer. The composite structures may comprise a single layer of anodized aluminum foil or multiple layers of anodized aluminum foil alone or in combination with other additional sheet materials. Suitable additional sheet materials include, but are not limited to, film layers, fiber-containing layers, foam layers, adhesive layers, particulate layers, or combinations thereof. Suitable film layers include, but are not limited to, thermosettable and thermoplastic polymeric films. Specific film layers include, but are not limited to, epoxy film layers, toughened epoxy film layers, cyanate ester film layers, polyimide film layers, bismaleimide (BMI) resin film layers, polyester film layers, polypropylene film layers, and combinations thereof. Suitable fiber-containing layers include, but are not limited to, fiberglass woven or nonwoven fabrics coated and/or impregnated with thermosettable resin (e.g., epoxy resin) or thermoplastic material (e.g., polypropylene).

Suitable fiber-containing layers include, but are not limited to, woven fabrics, nonwoven fabrics, knitted fabrics, unidirectional fabrics, or a combination thereof. The fiber-containing layers may be formed from a variety of fibers including, but not limited to, polymeric fibers, glass fibers, ceramic fibers, carbon fibers, metallic fibers, natural fibers, or a combination thereof. Desirably, the fiber-containing layer comprises one or more of the above-described fabrics at least partially coated and/or impregnated with one or more of the above-mentioned film materials.

Film layers and fiber-containing layers suitable for use in the composite structures of the present invention may comprise a variety of commercially available resin systems. Suitable resin systems include, but are not limited to, resin systems commercially available from Hexcel Corporation (Stamford, Conn.) under the trade designations M21, M50, 8552, F593, F584, F161, M73 and M36, all of which are toughened epoxy resin systems; the trade designations F263, 913, M74, 3501-6 and REDUX® products, such as REDUX® 330, all of which are epoxy resin systems; the trade designations F655, HP655, F650, M61 and M62, all of which are bismaleimide (BMI) resin systems; the trade designation F174, a polyimide resin system; and the trade designations 954-3A and 996, both of which are cyanate resin systems.

Suitable fiber reinforcements include, but are not limited to, glass woven fabrics commercially available from Hexcel Corporation (Stamford, Conn.) as style numbers: 104 (basis weight—about 20 grams per square meter (gsm)), 106 (basis weight—about 25 gsm), 108 (basis weight—about 48 gsm), 112 (basis weight—about 71 gsm), and 120 (basis weight—about 107 gsm), all of which are E-glass woven fabrics; and 6012 (basis weight—about 36 gsm), 6013 (basis weight—about 39 gsm), 6014 (basis weight—about 43 gsm), 6080 (basis weight—about 48 gsm), 4180 (basis weight—about 84 gsm), 4522 (basis weight—about 123 gsm), and 6581 (basis weight—about 303 gsm), all of which are S-glass woven fabrics.

The composite structures of the present invention desirably comprise at least one layer of anodized aluminum foil or expanded aluminum foil in combination with at least one additional layer. In one desired embodiment of the present invention, the composite structure comprises a layer of anodized aluminum foil or expanded aluminum foil and an additional layer on an outer surface of the foil layer. The additional layer may be any of the above-described layers.

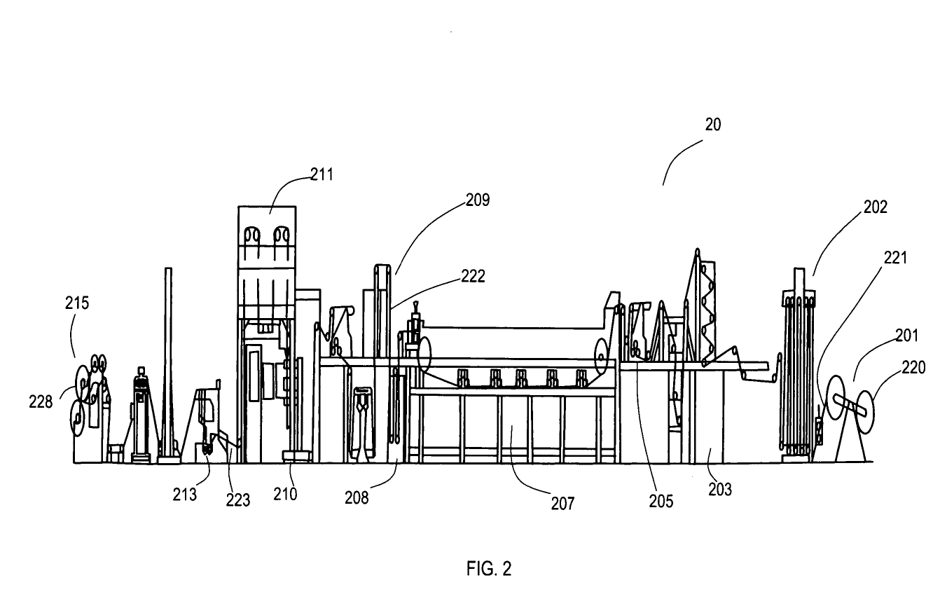

In a further embodiment of the present invention, the anodized aluminum foil is combined with at least one film layer and at least one fiber-containing layer to form a composite structure such as exemplary composite structure 30 shown in FIG. 3. As shown in FIG. 3, exemplary composite structure 30 comprises upper layer 301, lower layer 303, and intermediate layer 302 sandwiched between upper layer 301 and lower layer 303. In one exemplary embodiment of the present invention, composite structure 30 comprises upper layer 301 formed from a thermosettable film material, such as an epoxy or polyimide film; lower layer 303 comprising an S2 glass woven fabric; and intermediate layer 302 comprises an anodized expanded aluminum sheet material formed from the above-described continuous process. In this exemplary embodiment, the thermosettable film material (i.e., upper layer 301) may further comprise a fiber reinforcement within the thermosettable film material and/or the S2 glass woven fabric layer (i.e., lower layer 303) may further comprise a resin or polymeric material coating and/or impregnating the S2 glass woven fabric.

Composite structures formed from anodized aluminum sheet materials of the present invention may be used in a variety of applications. Suitable applications include, but are not limited to, aircraft components, vehicle components, and wind energy components. In one desired embodiment of the present invention, the composite structure is a component of an aircraft. When used as an outer layer of an aircraft component, the composite structure of the present invention provides exceptional lightning strike properties to the resulting aircraft component.

Other articles of manufacture may be prepared from the anodized aluminum sheet materials of the present invention and composite structures containing the same. Suitable articles of manufacture include, but are not limited to, commercial, military, and civil aviation components (i.e., aircraft and components of aircraft), wind energy components (i.e., wind propellers for generating energy), etc.

Articles of manufacture may be prepared from the anodized aluminum sheet materials of the present invention by any known method of combining the anodized aluminum sheet materials of the present invention with an additional article component, such as one or more of the above-described additional sheet materials.

In many articles of manufacture prepared from the anodized aluminum sheet materials and composite structures of the present invention, it is highly desirable to minimize the basis weight of the anodized aluminum sheet materials and/or composite structures containing the same. For example, when used to form an outer surface of an aircraft component, the composite structure of the present invention desirably has sufficient structural integrity for the given application, as well as a relatively low basis weight.

In one desired embodiment of the present invention, the composite structure has a two-ply composite structure comprising (i) a primed, anodized expanded aluminum sheet and (ii) a surfacing film layer (which may be optionally reinforced with a fiber reinforcement such as those described above) or a glass isolation layer (i.e., a glass fabric layer impregnated with one or more of the above-mentioned resin or polymeric materials). In this embodiment, the resulting two-ply composite structure has an overall basis weight ranging from less than about 66 grams per square meter (gsm) to greater than about 500 gsm. For example, the two-ply composite structure may comprise (i) a primed, anodized expanded aluminum sheet having a sheet thickness of 38.1μ (0.0015 in. (1.5 mil)) and a basis weight of about 36.6 gsm, and (ii) a surfacing film layer (e.g., an epoxy film layer) having a basis weight of about 30.0 gsm. In another example, the two-ply composite structure may comprise (i) a primed, anodized expanded aluminum sheet having a sheet thickness of 152.4μ (0.006 in. (6.0 mil)) and a basis weight of about 78.1 gsm, and (ii) a glass isolation layer (e.g., glass fabric Style 6581 (Hexcel Corporation, Stamford, Conn.) impregnated with an epoxy material) having a basis weight of about 420 gsm.

Typically, the two-ply composite structures of the present invention have an overall basis weight ranging from less than about 66 gsm to about 320 gsm, desirably, from less than about 66 gsm to about 200 gsm, and more desirably, from less than about 66 gsm to about 100 gsm. As discussed above, the resulting two-ply composite structure and overall basis weight for the resulting two-ply composite structure will vary depending on a particular application.

In a further desired embodiment of the present invention, the composite structure has a three-ply composite structure such as exemplary composite structure 30 shown in FIG. 3. In one exemplary embodiment, the three-ply composite structure comprises (i) a primed, anodized expanded aluminum sheet, (ii) a surfacing film layer (which may be optionally reinforced with a fiber reinforcement such as those described above) on a first outer surface of the primed, anodized expanded aluminum sheet, and

(iii) a glass isolation layer on an opposite outer surface of the primed, anodized expanded aluminum sheet. In this embodiment, the resulting three-ply composite structure has an overall basis weight ranging from less than about 115 gsm to greater than about 500 gsm. For example, the three-ply composite structure may comprise (i) a primed, anodized expanded aluminum sheet having a sheet thickness of 38.1μ (0.0015 in. (1.5 mil)) and a basis weight of about 36.6 gsm, (ii) a surfacing film layer (e.g., an epoxy film layer) having a basis weight of about 30.0 gsm, and (iii) a glass isolation layer (e.g., glass fabric Style 6012 (Hexcel Corporation, Stamford, Conn.) impregnated with an epoxy material) having a basis weight of about 48.8 gsm. In another example, the three-ply composite structure may comprise (i) a primed, anodized expanded aluminum sheet having a sheet thickness of 152.4μ (0.006 in. (6.0 mil)) and a basis weight of about 78.1 gsm, (ii) a surfacing film layer (e.g., an epoxy film layer) having a basis weight of about 244.0 gsm and (ii) a glass isolation layer (e.g., glass fabric Style 6080 (Hexcel Corporation, Stamford, Conn.) impregnated with an epoxy material) having a basis weight of about 73.2 gsm.

Typically, the three-ply composite structures of the present invention have an overall basis weight ranging from less than about 115 gsm to about 415 gsm, desirably, from less than about 115 gsm to about 230 gsm, and more desirably, from less than about 115 gsm to about 166 gsm. Similar to the two-ply composite structures, the resulting three-ply composite structure and overall basis weight for the resulting three-ply composite structure will vary depending on a particular application.

In one desired embodiment of the present invention, the three-ply composite structure comprises a structure similar to exemplary composite structure 30 shown in FIG. 3, wherein a resin matrix extends from an upper layer of the composite structure, through perforations in the anodized expanded aluminum foil layer, and to the lower layer of the composite structure. The resin matrix may comprise a single type of resin (e.g., an epoxy resin system) or may comprise two or more resin systems (e.g., an epoxy resin system in combination with a BMI resin system). As discussed above, in some desired embodiments, the resulting three-ply composite structure has a minimal basis weight within the ranges described above.

Any of the above-described composite structures of the present invention may be in sheet form or roll form. In one desired embodiment, the composite structure of the present invention is in roll form such that the composite structure can be unwound from a roll and further processed as needed. Rolls of composite material may have any desired length. Typically, the rolls of composite material have a roll length of up to about 304.8 m (1000 ft), and a roll width up to about 0.91 m (36 inches), although other roll dimensions (e.g., a greater roll width) are possible in the present invention.

The above-described two- and three-ply composite structures may be used as is or may be further combined with one or more additional layers to more complex composite structures. In one exemplary embodiment, the above-described two- and three-ply composite structures are combined with one or more of the following additional layers: a top coat layer (e.g., an outer surface layer, such as a polyurethane coating); a top coat primer layer that may be used to enhance the bond between a top coat layer and an upper layer of the two- and three-ply composite structure; a static conditioner layer applied onto an upper surface of an upper layer of the two- and three-ply composite structure after curing to fill pin holes, if any, within the upper surface; a prepreg layer bonded to a lower surface of the two- and three-ply composite structure (e.g., bonded to a lower surface of an EAF layer in the two-ply composite structure or to a lower surface of a glass isolation ply of the three-ply composite structure), wherein the prepreg comprises one or more of the above-described fiber-containing layers); one or more additional EAF layers; and combinations of any of the above additional layers.

In one desired embodiment, the complex composite structure of the present invention comprises the following layers in order from an upper surface layer to a back side layer: an optional top coat layer; an optional top coat primer layer; an optional static conditioner layer; an adhesive ply layer (also referred to above as a surfacing film layer (which may be optionally reinforced with a fiber reinforcement such as those described above)); a primed, anodized expanded aluminum sheet; an optional glass isolation layer; and a prepreg layer. In one desired embodiment, the complex composite structure comprises the following layers in order from an upper surface layer to a back side layer: a top coat layer comprising a polyurethane paint; a top coat primer layer; a static conditioner layer; a fiber-reinforced adhesive ply layer; a primed, anodized expanded aluminum sheet; a glass isolation layer; and a prepreg layer comprising layers of carbon fiber-reinforced epoxy resin matrix material.

The resulting composite structures or complex composite structures may be used to provide exceptional lightning strike properties to articles such as aircraft component, while maintaining a desired minimum overall thickness and basis weight. In one desired embodiment, the complex composite structures of the present invention comprise at least one anodized expanded aluminum sheet and one or more additional layers, and are capable of providing lightning strike protection from a Zone 1A lightning strike (or a Zone 2A or Zone 3 lightning strike) (all of which are described below) without sustaining any damage to a lower or interior surface (e.g., interior surface 409) of the complex composite structure (e.g., the interior surface delamination and puncture damage scores are both 0), even when having an overall composite thickness of less than about 1.60 mm (63 mil) and an overall composite basis weight of less than about 3000 gsm (or less than about 2800 gsm, or less than about 2500 gsm, or less than about 2200 gsm).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of a Roll of Anodized Aluminum Sheet Material

A roll of anodized aluminum sheet material was prepared using a continuous anodization process as described above on an apparatus similar to exemplary apparatus shown in FIG. 2. The processing details are given in Table 2 below.

TABLE 2
Process Parameter Details

| Variable | Value | Tolerance |
|---|---|---|
| Al Sheet Material: | — | — |
| various | — | — |
| width | 91.4 cm (36 in) | +2.54/−30.5 cm (+1/−12 in) |
| length | 1219.2 m (4000 ft) | +/−152.4 m (+/−500.0 ft) |
| thickness | 101.6 μm (0.004 in) | +/−12.7 μm (+/−0.0005 in) |
| Alkaline Wash: | — | — |
| alkaline material | — | — |
| concentration | 44.9 g/l (6 oz/gallon) | +/−15.0 g/l (+/−2 oz/gal) |
| spray pressure | reduced | — |
| Drive Rolls: | — | — |
| drive roll 1 tension | 14.71 kg/m² (1.5 psi) | +/−9.81 kg/m² (+/−1 psi) |
| drive roll 2 tension | 14.71 kg/m² (1.5 psi) | +/−9.81 kg/m² (+/−1 psi) |
| Anodizing Bath: | — | — |
| phosphoric acid | — | — |
| acid concentration | 210 g/L | +/−5.0 g/L |
| bath temperature | 105° C. | +/−1.0° C. |
| current | 750 amp/m² | +/−50.0 amp/m² |
| voltage | 20 volts | +/−10.0 volts |
| dwell time | 30 sec | +/−5.0 sec |
| dissolved Al | <6500 ppm | +500/−6000 ppm |
| Rinse Drying: | — | — |
| IR oven temp. | 93° C. (200° F.) | +/−1.0° C. |
| oven dwell time | 10 sec | +/−5.0 sec |
| Line Speed | 4.57 mpm | +/−1.52 mpm |
| | (15 fpm) | (+/−5.0 fpm) |

The resulting anodized aluminum sheet material had an aluminum oxide coating having an average oxide coating weight of about 1.5 grams per square meter (g/m²) on each side of the sheet material, and a surface morphology similar to that of the porous surface structure of a human bone.

### EXAMPLE 2

### Preparation of a Roll of Expanded Aluminum Foil

The procedure of Example 1 was repeated except that an expanded aluminum foil (EAF) sheet material was used. The EAF sheet material had the properties as shown in Table 3 below.

TABLE 3
EAF Sheet Material Properties

| Variable | Value | Tolerance |
|---|---|---|
| Al Sheet Material: | — | — |
| 7075-T6 | — | — |
| width | 91.4 cm (36 in) | +2.54/−30.5 cm (+1/−12 in) |
| length | 1219.2 m (4000 ft) | +/−304.8 m (+/−1000.0 ft) |
| thickness | 101.6 μm (0.004 in) | +/−12.7 μm (+/−0.0005 in) |
| perforation density | 107.5/m² (10/ft²) | +/−10.7/m² (+/−1/ft²) |
| perforation shape | diamond | — |
| perforation length | 2.54 cm (1.0 in) | +/−0.51 cm (+/−0.2 in) |
| perforation width | 2.54 cm (1.0 in) | +/−0.51 cm (+/−0.2 in) |

The resulting anodized EAF sheet material had an aluminum oxide coating having an average oxide coating weight of about 1.0 g/m² on each side of the sheet material, and a surface morphology similar to that of the porous surface structure of a human bone.

### EXAMPLE 3

### Preparation of a Roll of Expanded Aluminum Foil

The procedure of Example 2 was repeated except that the EAF sheet material had a sheet thickness of about 50.8μ (0.002 in (2 mil))+/−12.7μ (0.0005 in).

The resulting anodized EAF sheet material had an aluminum oxide coating having an average oxide coating weight of about 1.0 g/m² on each side of the sheet material, and a surface morphology similar to that of the porous surface structure of a human bone.

### EXAMPLE 4

### Preparation of a Roll of Primed Expanded Aluminum Foil

The procedure of Example 3 was repeated except that a primer coating was applied to the anodized EAF sheet material. The processing details are given in Table 4 below.

TABLE 4
Primer Application Details

| Variable | Value | Tolerance |
|---|---|---|
| Primer Material: | — | — |
| VARCUM | — | — |
| 94917 | | |
| concentration | 4.5 wt % solids | +/−1 wt % solids |
| coating weight | 860 mg/m²/side) | +/−107.5 mg/m²/side |
| | (80 mg/ft²/side) | (+/−10 mg/ft²/side) |
| Primer Curing: | — | — |
| zone 1 temperature | 121° C. (250° F.) | +/−1.0° C. |
| zone 2 temperature | 177° C. (350° F.) | +/−1.0° C. |
| cure time | 120 sec | +/−10.0 sec |

The resulting primed EAF sheet material had a primer coating having an average coating thickness weight 0.86 g/m²/side) (80 mg/ft²/side).

### EXAMPLE 5

### Preparation of a Roll of Primed Expanded Aluminum Foil

The procedure of Example 4 was repeated except that the following expanded aluminum foil sheet materials were used as shown in Table 5 below.

TABLE 5
Expanded Aluminum Foil (EAF) Sheet Material Details

| | | | | Primed |
|---|---|---|---|---|
| EAF | | | EAF | Anodized |
| Sample | | EAF | Basis | EAF Basis |
| No. | EAF Thickness | Width | Weight | Weight |
| 1 | 38.1 μm | 91.4 cm. | 36.6 gsm | 40.3 gsm |
| | (1.5 mil) | (36 in.) | | |
| | (flattened) | | | |
| 2 | 50.8 μm | 61.0 cm. | 63.5 gsm | 67.6 gsm |
| | (2.0 mil) | (24 in.) | | |
| | (flattened) | | | |
| 3 | 50.8 μm | 91.4 cm. | 42.0 gsm | 46.7 gsm |
| | (2.0 mil) | (36 in.) | | |
| | (flattened) | | | |
| 4 | 50.8 μm | 91.4 cm. | 48.8 gsm | 54.1 gsm |
| | (2.0 mil) | (36 in.) | | |
| | (flattened) | | | |
| 5 | 101.6 μm | 91.4 cm. | 78.1 gsm | 81.8 gsm |
| | (4.0 mil) | (36 in.) | | |
| | (flattened) | | | |
| 6 | 152.4 μm | 91.4 cm. | 78.1 gsm | 83.8 gsm |
| | (6.0 mil) | (36 in.) | | |
| | (4.0 mil, not | | | |
| | flattened) | | | |

### EXAMPLE 6

### Preparation of Two-Ply Composite Structures

A variety of two-ply composite structures was prepared by combining the primed EAF sheet materials shown in Table 5 with various additional layers as shown in Table 6 below.

TABLE 6
Two-Ply Composite Structure Details

| Two-Ply | EAF | Additional Layer | | Two-Ply |
|---|---|---|---|---|
| Composite | Sample | | Glass | Composite |
| Sample | No. | Surfacing | Isolation Ply | Basis |
| No. | Used | Film | (Resin/Fabric) | Weight |
| 1 | 1 | M50 | | 69 gsm |
| 2 | 2 | REDUX ® | | 136 gsm |
| | | 330 | | |
| 3 | 3 | F655 | | 84 gsm |
| 4 | 4 | F650 | | 82 gsm |
| 5 | 5 | M61 | | 239 gsm |
| 6 | 6 | M50 | | 322 gsm |
| 7 | 1 | | M50/104 | 89 gsm |
| 8 | 2 | | F161/106 | 186 gsm |
| 9 | 3 | | M74/6012 | 107 gsm |
| 10 | 4 | | F650/4180 | 176 gsm |
| 11 | 5 | | F655/104 | 151 gsm |
| 12 | 6 | | 954-3A/112 | 179 gsm |

### EXAMPLE 7

### Preparation of Three-Ply Composite Structures

Three-ply composite structures were prepared by combining the primed EAF sheet materials shown in Table 5 with two additional layers as shown in Table 7 below.

TABLE 7
Three-Ply Composite Structure Details

| Three-Ply | EAF | Additional Layer | | Three-Ply |
|---|---|---|---|---|
| Composite | Sample | | Glass | Composite |
| Sample | No. | Surfacing | Isolation Ply | Basis |
| No. | Used | Film | (Resin/Fabric) | Weight |
| 1 | 1 | M50 | M50/6012 | 146 gsm |
| 2 | 2 | REDUX ® | F161/6012 | 205 gsm |
| | | 330 | | |
| 3 | 3 | F655 | F650/6014 | 220 gsm |
| 4 | 4 | HP655 | F650/6080 | 229 gsm |
| 5 | 5 | M50 | 996/6012 | 308 gsm |
| 6 | 5 | REDUX ® | 954-3A/6014 | 322 gsm |
| | | 330 | | |
| 7 | 5 | REDUX ® | M50/6080 | 332 gsm |
| | | 330 | | |
| 8 | 5 | M50 | F161/4180 | 381 gsm |
| 9 | 6 | M50 | M50/6012 | 391 gsm |
| 10 | 6 | HP655 | F650/6080 | 415 gsm |

### EXAMPLE 8

### Lightning Strike Performance of Composite Structures

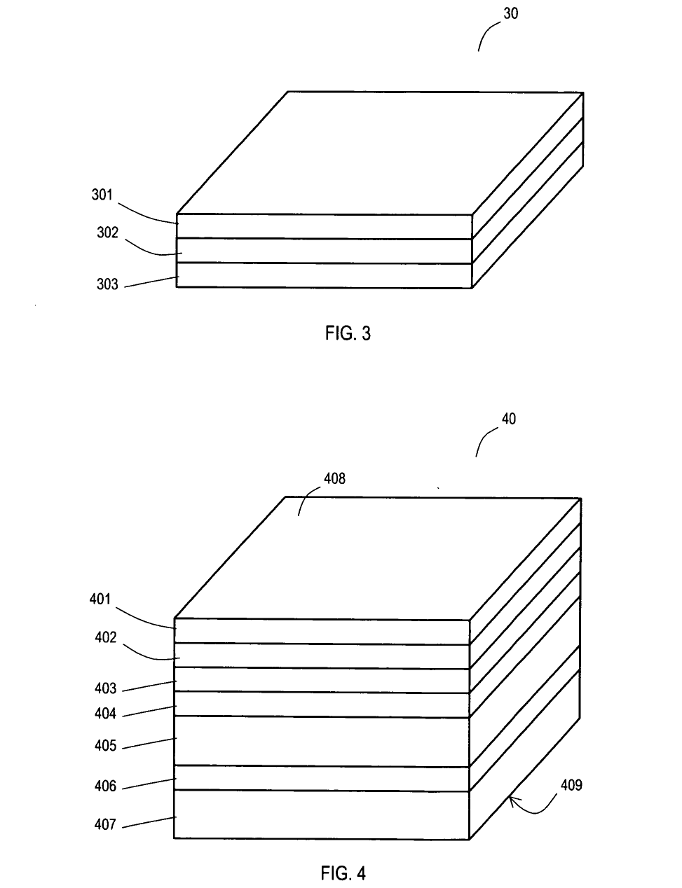

Composite structures (i.e., “LS Composite Samples”) were prepared by combining EAF sheet materials shown in Table 5 with one or more additional layers to form LS Composite Samples having a composite structure as shown in FIG. 4. As shown in FIG. 4, exemplary LS Composite Sample 40 comprises an optional top coat layer 401, an optional top coat primer layer 402, an optional static conditioner layer 403, an adhesive ply layer 404, an EAF layer 405, an optional glass isolation ply layer 406, and a prepreg layer 407.

In each LS Composite Sample, the following steps were taken to form the composite sample:
(1) EAF layer 405 was formed as described above in Examples 1-5;
(2) layers of the sample were assembled in the following order: adhesive ply layer 404, EAF layer 405, glass isolation ply layer 406 (when present), and prepreg layer 407;
(4) the assembly was cured in an autoclave within a vacuum bag at about 179.4° C.±5.6° C. (355° F.±10° F.) for 120 minutes under a pressure of 833.6 kg/m² (85 psig);
(5) a minimal amount (typically less than about 30 gsm) of a static conditioner coating Static Conditional 28-C-1 commercially available from Dexter Aerospace Materials Division (Waukegan, Ill.) was optionally applied onto an outer surface of the cured assembly (i.e., an outer surface of adhesive ply layer 404) to fill any pin holes formed in adhesive ply layer 404 during the curing step;
(6) a top coat primer layer 402 was optionally applied over adhesive ply layer 404 using a top coat primer material comprising BMS 10-103 certified Deft 45-GY-5 primer material commercially available from Deft, Inc. (Irvine, Calif.); and
(7) a top coat layer 401 was optionally applied over top coat primer layer 402 using a top coat material comprising a high solids (420 g/l) polyurethane top coat for use under Boeing specification BMS 10-60, which is commercially available from PRC-DeSoto International, a division of PPG Industries (Pittsburgh, Pa.), under the trade designation CA8000/B707X.

Table 8 below provides further details of LS Composite Samples of the present invention. Each panel had the following overall dimensions: width—about 45.7 cm (18 in), length—about 50.8 cm (20 in), and thickness—up to about 1.6 mm (0.063 in).

LS Composite samples were subjected to Zone 1A, Zone 2A and Zone 3 lightning strikes, wherein Zone 1A, Zone 2A and Zone 3 lightning strikes are described below. All testing was performed by Lightning Technologies, Inc. (LTI) in their lightning laboratory located in Pittsfield, Mass.

Zone 1A requires application of Components A, B, and C*, Zone 2A requires Components D, B, and C*, and Zone 3 requires Components A (at 40 kA), B, and C* which are defined as follows:
Component A: Peak current amplitude (Iₚₖ)=200 kA±10% Action integral (AI)=2.00×10⁶A²·s±20%
Component B: Average current amplitude=2 kA±20% Maximum charge transfer=10 coulombs±10%
Component C*: Average current amplitude (Iₐᵥ)≧400 A Charge transfer=18° C.±20%
Component D: Peak current amplitude (Iₚₖ)=100 kA±10% Action integral (AI)=0.25×10⁶ A²·s±20%.

Components A and B were generated by capacitor banks which were discharged through series impedance into the test article. Component C* was generated by the partial discharge of a dc battery bank with the discharge duration controlled by a cutout fuse.

Component A waveforms were measured by a current probe and an attenuator and Components B and C* by precision shunt resistors.

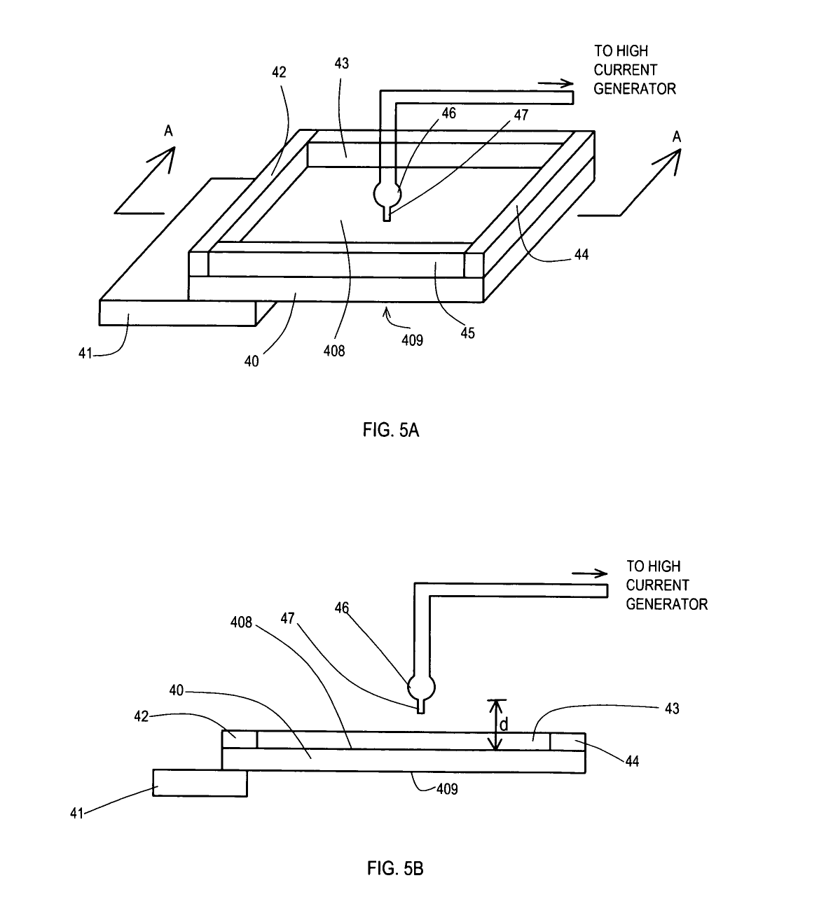

The panel to be tested was mounted in a test apparatus similar to exemplary test apparatus 50 shown in FIGS. 5A-5B. As shown in FIGS. 5A-5B, test composite sample 40 was mounted horizontally at the high current generator (not shown) in a manner that allowed one side of composite sample 40 to be connected to a generator ground bus 41. Aluminum bar stock 42, 43, 44 and 45 was clamped to the remaining three sides (and the generator ground bus side) of composite sample 40 and electrically connected to allow currents to exit from each of the four sides of composite sample 40. A jet-diverting electrode 46 was centrally positioned over composite sample 40 at a distance, d, of 5.1 cm (2.0 in) between upper surface 408 of composite sample 40 and the nearest conductive portion of electrode 46. A 0.1 mm diameter arc initiating wire 47 extended from electrode 46 approximately 6.4 mm (0.25 in) from upper surface 408. Wire 47 was used to help initiate high current discharge.

Each panel received one high current Zone 1A, Zone 2A, or Zone 3 strike from electrode 46. The applied current levels are shown in Table 9 below. In a few cases, the dielectric strength of the panel surface (i.e., upper surface 408) prevented current entry into the panel (e.g., LS Composite Samples 9** and 10** shown in Table 9). In these cases, a 1.6 mm ( 1/16 in) diameter hole was formed through the paint with a drill bit to allow current to enter the panel material.

Post-test damage is tabulated in Table 10. The values shown in Table 10 refer to a longest damage dimension. A panel with damage over an oval area of 5.1 cm (2.0 in)×7.6 cm (3.0 in) would be listed as a damage score of 3.0. A designation of 1+2 means that two locations were damaged with longest dimensions of 2.5 cm (1.0 in) and 5.1 cm (2.0 in). When multiple locations were present, the longest dimension of the multiple locations was used as the damage score.

A weighted “Total Score” was calculated for each panel based on the following multipliers assigned to each of the damage components:

Damage Characteristic:

| | Multiplier: |
|---|---|
| Exterior Surface (i.e., outer surface 408): | |
| Paint Damage | 1 |
| Delamination | 2 |
| Fiber Damage | 2 |
| Puncture | 5 |
| Interior Surface (i.e., outer surface 409): | |
| Delamination | 7.5 |
| Puncture | 15 |

The Total Score for each panel was determined by adding the products of each given damage score by each of its corresponding multiplier. For example, a Total Score for LS Composite Sample No. 7 was determined as follows:
Total Score=[(Paint Damage Score)×(Paint Damage Multiplier)+(Exterior Surface Delamination Score)×(Exterior Surface Delamination Multiplier)+(Fiber Damage Score)×(Fiber Damage Multiplier)+(Exterior Surface Puncture Score)×(Exterior Surface Puncture Multiplier)+(Interior Surface Delamination Score)×(Interior Surface Delamination Multiplier)+(Interior Surface Puncture Score)×(Interior Surface Puncture Multiplier)]
Total Score=[(3)(1)+(3)(2)+(3)(2)+(2)(5)+(3.5)(7.5)+(2)(15)]
Total Score=81.25

Using the Total Score method, paint damage to a given test composite sample is given little weight, while a puncture of an interior surface (i.e., outer surface 409) is given much greater weight. A lower “Total Score” indicates a better performing panel (i.e., a panel that experiences less damage relative to other panels exposed to the same lightning strike level, such as a Zone 1A lightning strike level).

TABLE 8
LS Composite Structure Details

| | | | Composite Layers | | | | | | |
|---|---|---|---|---|---|---|---|---|---|
| | | | (provided in order from top coat surfacing film layer (when present) to bottom prepreg layer) | | | | | | |
| LS | | Overall | | | | | EAF | Glass | |
| Composite | Overall | Basis | | Top Coat | Static | | Sample | Isolation Ply | |
| Sample | Thickness | Weight | | Primer | Conditioner | Adhesive | No. | (Resin/ | Prepreg Layer |
| No. | mm (mil) | gms | Top Coat Layer | Layer | Layer | Ply | Used | Fabric) | (Resin/Fabric) |
| 1 | 1.57 mm | about | BMS 10-60/PRC | Deft 45- | 28-C-1 | 1 ply of | 4 | 1 ply of | 6 plies of |
| | (62 mil) | 2605 | Desoto | GY-5 | coating | PL-795 | | M50/6080 | M21/SPG196P |
| | | | CA8000/B707X | thickness - | | adhesive¹ | | (0°/90°)² | (0°/90°)³ |
| | | | thickness - 203.2 μm | 20 μm | | | | | |
| | | | (8 mil) | (<1 mil) | | | | | |
| 2 | 1.60 mm | about | BMS 10-60/PRC | Deft 45- | 28-C-1 | 1 ply of | 4 | 1 ply of | 6 plies of |
| | (63 mil) | 2626 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 3 | 1.60 mm | about | BMS 10-60/PRC | Deft 45- | 28-C-1 | 1 ply of | 4 | 1 ply of | 6 plies of |
| | (63 mil) | 2519 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 4 | — | — | BMS 10-60/PRC | Deft 45- | 28-C-1 | 1 ply of | 4 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 5 | — | — | BMS 10-60/PRC | Deft 45- | 28-C-1 | 1 ply of | 4 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 6 | 1.60 mm | about | BMS 10-60/PRC | Deft 45- | 28-C-1 | 1 ply of | 4 | 1 ply of | 6 plies of |
| | (63 mil) | 2540 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 7 | 1.57 mm | about | BMS 10-60/PRC | Deft 45- | 28-C-1 | 1 ply of | 4 | 1 ply of | 6 plies of |
| | (62 mil) | 2885 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 8 | 1.57 mm | about | BMS 10-60/PRC | Deft 45- | 28-C-1 | 1 ply of | 4 | 1 ply of | 6 plies of |
| | (62 mil) | 2820 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 9 | — | — | BMS 10-60/PRC | Deft 45- | 28-C-1 | 1 ply of | 4 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 10 | — | — | BMS 10-60/PRC | Deft 45- | 28-C-1 | 1 ply of | 4 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 11 | 1.60 mm | about | none | none | none | 1 ply of | 5 | 1 ply of | 6 plies of |
| | (63 mil) | 2282 | | | | PL-795 | | M50/6080 | M21/SPG196P |
| | | | | | | adhesive | | (0°/90°) | (0°/90°) |
| 12 | 1.60 mm | about | none | none | none | 1 ply of | 5 | 1 ply of | 6 plies of |
| | (63 mil) | 2282 | | | | PL-795 | | M50/6080 | M21/SPG196P |
| | | | | | | adhesive | | (0°/90°) | (0°/90°) |
| 13 | — | — | none | none | none | 1 ply of | 5 | 1 ply of | 6 plies of |
| | | | | | | PL-795 | | M50/6080 | M21/SPG196P |
| | | | | | | adhesive | | (0°/90°) | (0°/90°) |
| 14 | — | — | none | none | none | 1 ply of | 5 | 1 ply of | 6 plies of |
| | | | | | | PL-795 | | M50/6080 | M21/SPG196P |
| | | | | | | adhesive | | (0°/90°) | (0°/90°) |
| 15 | 1.57 mm | about | BMS 10-60/PRC | Deft 45- | 28-C-1 | 1 ply of | 5 | 1 ply of | 6 plies of |
| | (62 mil) | 2519 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 16 | 1.57 mm | about | BMS 10-60/PRC | Deft 45- | 28-C-1 | 1 ply of | 5 | 1 ply of | 6 plies of |
| | (62 mil) | 2519 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 17 | — | — | BMS 10-60/PRC | Deft 45- | 28-C-1 | 1 ply of | 5 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 18 | — | — | BMS 10-60/PRC | Deft 45- | 28-C-1 | 1 ply of | 5 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 203.2 μm | 20 μm | | | | | |
| | | | (8 mil) | (<1 mil) | | | | | |
| 19 | 1.52 mm | about | BMS 10-60/PRC | Deft 45- | 28-C-1 | 1 ply of | 5 | none | 5 plies of |
| | (60 mil) | 2519 | Desoto | GY-5 | coating | PL-795 | | | M21/SPG196P |
| | | | CA8000/B707X | thickness - | | adhesive | | | (0°/90°) and |
| | | | thickness - 203.2 μm | 20 μm | | | | | 1 ply of |
| | | | (8 mil) | (<1 mil) | | | | | M50/T300PW⁴ |
| 20 | 1.52 mm | about | BMS 10-60/PRC | Deft 45- | 28-C-1 | 1 ply of | 5 | none | 5 plies of |
| | (60 mil) | 2519 | Desoto | GY-5 | coating | PL-795 | | | M21/SPG196P |
| | | | CA8000/B707X | thickness - | | adhesive | | | (0°/90°) and |
| | | | thickness - 203.2 μm | 20 μm | | | | | 1 ply of |
| | | | (8 mil) | (<1 mil) | | | | | M50/T300PW |
| 21 | 1.52 mm | about | BMS 10-60/PRC | Deft 45- | 28-C-1 | 1 ply of | 5 | none | 5 plies of |
| | (60 mil) | 2519 | Desoto | GY-5 | coating | PL-795 | | | M21/SPG196P |
| | | | CA8000/B707X | thickness - | | adhesive | | | (0°/90°) and |
| | | | thickness - 203.2 μm | 20 μm | | | | | 1 ply of |
| | | | (8 mil) | (<1 mil) | | | | | M50/T300PW |
| 22 | — | — | BMS 10-60/PRC | Deft 45- | 28-C-1 | 1 ply of | 5 | none | 5 plies of |
| | | | Desoto | GY-5 | coating | PL-795 | | | M21/SPG196P |
| | | | CA8000/B707X | thickness - | | adhesive | | | (0°/90°) and |
| | | | thickness - 203.2 μm | 20 μm | | | | | 1 ply of |
| | | | (8 mil) | (<1 mil) | | | | | M50/T300PW |
| 23 | — | — | BMS 10-60/PRC | Deft 45- | 28-C-1 | 1 ply of | 5 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 24 | 1.57 mm | about | BMS 10-60/PRC | Deft 45- | 28-C-1 | 1 ply of | 5 | 1 ply of | 6 plies of |
| | (62 mil) | 2648 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 25 | 1.57 mm | about | BMS 10-60/PRC | Deft 45- | 28-C-1 | 1 ply of | 5 | 1 ply of | 6 plies of |
| | (62 mil) | 2626 | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| 26 | — | — | BMS 10-60/PRC | Deft 45- | 28-C-1 | 1 ply of | 5 | 1 ply of | 6 plies of |
| | | | Desoto | GY-5 | coating | PL-795 | | M50/6080 | M21/SPG196P |
| | | | CA8000/B707X | thickness - | | adhesive | | (0°/90°) | (0°/90°) |
| | | | thickness - 304.8 μm | 20 μm | | | | | |
| | | | (12 mil) | (<1 mil) | | | | | |
| ¹The PL-795 adhesive ply comprises an epoxy adhesive film commercially available from Henkel Corporation (Bay Point, CA). | | | | | | | | | |
| ²M50/6080 (0°/90°) is used to designate a woven fabric of S2 glass (Style 6080) having a fabric width of 96.5 cm (38 in) that has been impregnated with M21 toughened epoxy resin such that the epoxy resin component represents 34 wt % of the ply, and the ply is oriented so that the warp and weft of the fabric are oriented at 0° and 90° relative to a length of the composite sample. Both the woven glass fabric and the M50 resin | | | | | | | | | |
| # system are commercially available from Hexcel Corporation (Stamford, CT). | | | | | | | | | |
| ³M21/SPG196P is used to designate a woven fabric of carbon fibers (plain weave of IM7 6 K fibers having an areal weight of 196 gsm) having a fabric width of 96.5 cm (38 in) that has been impregnated with M21 toughened epoxy resin such that the epoxy resin component represents 40 wt % of the ply, and the ply is oriented so that the warp and weft of the fabric are oriented at 0° and 90° relative to a length of the | | | | | | | | | |
| # composite sample. Both the woven carbon fabric and the M21 epoxy resin system are commercially available from Hexcel Corporation (Stamford, CT). | | | | | | | | | |
| ⁴M50/T300PW is used to designate a woven fabric of carbon fibers (Style 282) having a fabric width of 152.4 cm (60 in) that has been impregnated with M50 toughened epoxy resin such that the epoxy resin component represents 40 wt % of the ply, and the ply is oriented so that the warp and weft of the fabric are oriented at 0° and 90° relative to a length of the composite sample. Both the woven carbon fabric (Style 282) and the M50 | | | | | | | | | |
| # resin system are commercially available from Hexcel Corporation (Stamford, CT). | | | | | | | | | |

TABLE 9
LS Composite Lightning Strike - Applied Current Levels

| LS | | | | | | |
|---|---|---|---|---|---|---|
| Com- | | | | | | |
| posite | Component A/D | | | | | |
| Sample | | AI × | Component B | | Component C* | |
| No. | Iₚₖ (kA) | 10⁶ (A² · s) | Iₚₖ (kA) | Charge | Iₐᵥ (A) | Charge |
| 21 | 206 | 2.0 | 4.0 | 10.1 | — | — |
| 20 | 200 | 1.8 | 4.0 | 10.2 | 624 | 15.6 |
| 19 | 206 | 2.0 | 4.0 | 10.1 | 393 | 22.0 |
| 15 | 206 | 2.0 | 4.0 | 10.1 | 646 | 15.5 |
| 16 | 206 | 2.0 | 4.0 | 10.2 | 572 | 16.6 |
| 11 | 210 | 2.3 | 4.0 | 10.3 | 600 | 16.2 |
| 12 | 200 | 2.1 | 4.0 | 10.1 | 604 | 15.7 |
| 1 | 200 | 1.8 | 4.0 | 10.2 | 488 | 20.0 |
| 2 | 200 | 1.8 | 4.0 | 10.1 | 586 | 17.0 |
| 22 | 112 | 0.27 | 4.0 | 9.7 | 465 | 18.6 |
| 6 | 112 | 0.26 | 4.0 | 10.0 | 579 | 16.2 |
| 17 | 110 | 0.26 | 4.0 | 10.0 | 575 | 16.1 |
| 18 | 107 | 0.24 | 4.0 | 10.2 | 625 | 15.0 |
| 23 | 106 | 0.24 | 4.0 | 10.1 | 612 | 15.3 |
| 24 | 106 | 0.24 | 3.6 | 10.0 | 555 | 17.2 |
| 13 | 108 | 0.25 | 4.0 | 10.0 | 625 | 15.0 |
| 14 | 108 | 0.25 | 4.0 | 10.1 | 633 | 15.2 |
| 3 | 108 | 0.24 | 4.0 | 10.2 | 593 | 16.0 |
| 4 | 108 | 0.24 | 4.0 | 10.1 | 582 | 16.3 |
| 5 | 108 | 0.24 | 4.0 | 10.1 | 531 | 17.0 |
| 7 | 106 | 0.24 | 4.0 | 10.0 | 553 | 16.6 |
| 8 | 105 | 0.24 | 4.0 | 10.1 | 572 | 16.6 |
| 25 | 41 | 0.085 | 3.9 | 10.2 | 640 | 16.0 |
| 26 | 40 | 0.088 | 3.9 | 10.1 | 633 | 15.2 |
| 9 | 40 | 0.084 | 3.9 | 10.1 | 425 | 20.4 |
| 10 | 40 | 0.084 | 3.9 | 10.0 | 593 | 16.6 |
| 10** | 42 | 0.080 | 3.9 | 10.2 | 567 | 17.0 |
| 9** | 47 | 0.080 | 3.9 | 10.0 | 586 | 17.0 |

**Test performed after panel was pre-punctured with 1.6 mm ( 1/16 in) drill bit.

TABLE 10
LS Composite Lightning Strike Properties

| LS | | | | | | Interior Surface | | |
|---|---|---|---|---|---|---|---|---|
| Composite | | Exterior Surface (i.e., outer surface 408) | | | | (i.e., outer surface 409) | | Total |
| Sample No. | Zone | Paint/Mesh Damage | Delamination | Fiber Damage | Puncture | Delamination | Puncture | Score |
| 21 | 1A | 5 | 15 (cracked) | 2 | 15 (cracked) | 15 (cracked) | 15 (cracked) | 451.5 |
| 20 | 1A | 5 | 15 (cracked) | 3 | 2 | 15 (cracked) | 15 (cracked) | 388.5 |
| 19 | 1A | 5 | 5 | 2 | 15 (cracked) | 15 (cracked) | 15 (cracked) | 431.5 |
| 15 | 1A | 6 | 0 | 0 | 0 | 0 | 0 | 6 |
| 16 | 1A | 6 | 0 | 15 (cracked) | 15 (cracked) | 15 (cracked) | 15 (cracked) | 448.5 |
| 11 | 1A | 0 | 0 | 0 | 0 | 0 | 0 | 0 |
| 12 | 1A | 0 | 0 | 0 | 0 | 0 | 0 | 0 |
| 1 | 1A | 7 | 0 | 15 (cracked) | 1 | 15 (cracked) | 15 (cracked) | 379.5 |
| 2 | 1A | 7 | 0 | 15 (cracked) | 1 | 15 (cracked) | 15 (cracked) | 379.5 |
| 22 | 2A | 2.5 | 0 | 0 | 0 | 0 | 0 | 2.5 |
| 6 | 2A | 3 | 0 | 0 | 0 | 0 | 0 | 3 |
| 17 | 2A | 1 + 2 | 0 | 0 | 0 | 0 | 0 | 2 |
| 18 | 2A | 3 | 0 | 0 | 0 | 0 | 0 | 3 |
| 23 | 2A | 2 | 0 | 0.5 | 0 | 0 | 0 | 3 |
| 24 | 2A | 2 | 0 | 0.5 | 0 | 0 | 0 | 3 |
| 13 | 2A | 0 | 0 | 0 | 0 | 0 | 0 | 0 |
| 14 | 2A | 0 | 0 | 0 | 0 | 0 | 0 | 0 |
| 3 | 2A | 3.5 | 0 | 0.5 | 0 | 0 | 0 | 4.5 |
| 4 | 2A | 2.5 | 0.5 | 0.5 | 0 | 0 | 0 | 4.5 |
| 5 | 2A | 2.5 | 0 | 0.5 | 0 | 0 | 0 | 3.5 |
| 7 | 2A | 3 | 3 | 3 | 2 | 3.5 | 2 | 81.25 |
| 8 | 2A | 3 | 3 | 3 | 1.5 | 4 | 1.8 | 79.5 |
| 25 | 3 | 2 | 0 | 0 | 0 | 0 | 0 | 2 |
| 26 | 3 | 0.5 + 0.5 | 1 + 2 | 0 | 0 | 0 | 0 | 4.5 |
| 9** | 3 | 1.5 | 1 | 1 | 0 | 0 | 0 | 5.5 |
| 10** | 3 | 1.5 | 0.5 | 0.5 | 0 | 0 | 0 | 3.5 |

As shown above, test composite samples were capable of being subjected to Zone 1A, Zone 2A or Zone 3 lightning strikes with varying degrees of damage. Desirably, the test composite sample was capable of being subjected to a Zone 1A, Zone 2A or Zone 3 lightning strike and have a Total Score of less than about 500 (or less than about 450, or less than about 400, or less than about 350, or less than about 300, or less than about 250, or less than about 200, or less than about 150, or less than about 100, or less than about 50). More desirably, the test composite sample was capable of being subjected to a Zone 1A, Zone 2A or Zone 3 lightning strike and have a Total Score of less than about 10, or less than about 5, or 0.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A process for forming an anodized aluminum foil sheet material, said process comprising:
continuously feeding a sheet of aluminum foil into an anodizing bath, wherein said sheet of aluminum foil comprises (i) a sheet of expanded aluminum foil, (ii) a sheet having a sheet thickness of less than about 101.6μ (0.004 inch (4 mil)), or (iii) both (i) and (ii); and
anodizing said sheet of aluminum foil to form an anodized sheet of aluminum foil, wherein said anodized sheet of aluminum foil has a final sheet width of up to about 1.83 m (6 ft) and a final length of greater than 2.44 m (8 ft).

2. The process of claim 1, further comprising
taking up said anodized sheet of aluminum foil to form a roll of anodized sheet of aluminum foil having a roll width of up to about 1.83 m (6 ft), said anodized sheet of aluminum foil has a final length of up to about 1524 m (5000 ft).

3. The process of claim 1, wherein said sheet of aluminum foil has a sheet thickness ranging from about 38.1μ (0.0015 inch (1.5 mil)) to about 101.6μ (0.004 inch (4 mil)).

4. The process of claim 1, wherein said sheet of aluminum foil comprises a sheet of expanded aluminum foil having a plurality of perforations through the sheet, wherein each of the plurality of perforations has an average perforation length of up to about 2.5 cm, and an average perforation width of up to about 2.5 cm.

5. The process of claim 4, wherein the plurality of perforations are substantially uniformly distributed over the sheet.

6. The process of claim 1, further comprising
providing an unexpanded sheet of aluminum foil having a first width;
perforating the unexpanded sheet of aluminum foil to form a perforated unexpanded sheet;
expanding the perforated unexpanded sheet to form a perforated expanded sheet having a second width less than the first width; and
optionally flattening the perforated expanded sheet to form a sheet of expanded aluminum foil,
wherein said providing, perforating, expanding and optional flattening steps are performed prior to or after said anodizing step.

7. The process of claim 1, further comprising one or more of the following steps:
unwinding said sheet of aluminum foil from a roll of aluminum foil;
maintaining a line speed of up to about 4.57 meters per minute (15 fpm);
washing said sheet of aluminum foil with an alkaline solution prior to the anodizing step;
subjecting said sheet of aluminum foil to one or more rinsing steps;
subjecting said sheet of aluminum foil to one or more drying steps;
applying a primer to said anodized sheet of aluminum foil;
curing a primer applied to said anodized sheet of aluminum foil; and
taking up said anodized sheet of aluminum foil to form a roll of anodized sheet of aluminum foil.

8. The process of claim 1, further comprising:
washing said sheet of aluminum foil with an alkaline solution, prior to the anodizing step, to form a washed sheet;
rinsing the washed sheet with deionized water to form a rinsed sheet;
anodizing the rinsed sheet in an anodizing bath containing phosphoric acid to form said anodized sheet of aluminum foil;
rinsing said anodized sheet with deionized water to form a rinsed anodized sheet;
drying the rinsed anodized sheet at a drying temperature of up to about 93° C. to form a dried anodized sheet;
applying a primer to the dried anodized sheet, said primer comprising a phenolic resin; and
curing the primer at a curing temperature of up to about 177° C. to form a primed anodized sheet.

9. The process of claim 8, further comprising:
applying a surfacing layer with or without fiber reinforcement onto at least one outer surface of the primed anodized sheet.

10. The process of claim 8, wherein a surfacing film with or without fiber reinforcement is applied to one outer surface of the primed anodized sheet, and a glass fabric is applied to an opposite outer surface of the primed anodized sheet.

11. The process of claim 1, wherein said sheet of aluminum foil is exposed to a maximum tension of up to about 19.61 kg/m² (2 psi), a maximum electrical current of up to about 800 amps/m², a maximum anodizing temperature of up to about 107° C. (225° F.), and a maximum line speed of about 15 feet per minute (fpm) during the process.

12. The process of claim 1, wherein the process comprises:
unwinding a sheet of expanded aluminum foil from a continuous roll of expanded aluminum foil having a roll length of up to or greater than 1524 m (5000 ft);
maintaining a line tension of less than about 19.61 kg/m² (2 psi) and a line speed of up to about 4.57 meters per minute (15 fpm);
washing the sheet of expanded aluminum foil with an alkaline solution;
rinsing the sheet of expanded aluminum foil with deionized water after the wash step;
passing the sheet of expanded aluminum foil through a phosphoric acid anodizing bath having bath parameters as follows to form an anodized sheet:

| | |
|---|---|
| H⁺ concentration | 100 to 250 g/L |
| dwell time | 30 seconds to |
| | 5 minutes |
| bath temperature | ˜80 to ˜140° C. |
| electrical current | ˜600 to ˜900 amp/m² |
| voltage | ˜2 to ˜60 volts |
| dissolved Al | <9000 ppm |

drying the anodized sheet at a drying temperature of less than about 93° C. (200° F.);
applying a primer coating to the dried anodized sheet at a primer coating weight of about 0.65 g/m² (60 mg/ft²) to about 1.08 g/m² (100 mg/ft²) of primer on each side of the dried anodized sheet;
curing the primer coating at a cure temperature of less than about 177° C. (350° F.); and
taking up the primed, anodized sheet of expanded aluminum foil while maintaining a line tension of less than about 19.61 kg/m² (2 psi).

13. The process of claim 12, wherein the phosphoric acid anodizing bath has the following bath parameters:

| | |
|---|---|
| H⁺ concentration | 180 to 210 g/L |
| dwell time | 30 seconds to |
| | 2 minutes |
| bath temperature | ˜104° C. to ˜107° C. |
| electrical current | ˜700 to ˜800 amp/m² |
| voltage | ˜10 to ˜40 volts |
| dissolved Al | <7000 ppm |

14. An anodized sheet of expanded aluminum foil formed by the process according to claim 13.

15. An article of manufacture comprising an anodized sheet of aluminum foil formed by the process according to claim 1 and at least one additional layer on an outer surface of the anodized sheet of aluminum foil.

16. An anodized sheet of expanded aluminum foil having a final sheet width of up to about 1.83 m (6 ft) and a final sheet length ranging from about 304.8 m (1000 ft) to about 1524 m (5000 ft).

17. A roll of sheet material, wherein the sheet material comprises the sheet of claim 16.

18. A composite structure comprising:
an anodized sheet of expanded aluminum foil having a sheet thickness ranging from about 38.1μ (0.0015 inch (1.5 mil)) to about 101.6μ (0.004 inch (4 mil)); and
at least one additional layer on an outer surface of the anodized sheet of expanded aluminum foil.

19. The composite structure of claim 18, wherein the at least one additional layer comprises a film layer, a fiber-containing layer, a foam layer, an adhesive layer, a particulate layer, or a combination thereof.

20. The composite structure of claim 18, wherein a surfacing film comprising a first resin system with or without fiber reinforcement is applied to one outer surface of the anodized sheet of expanded aluminum foil, and a fiber-reinforced layer comprising a second resin system is applied to an opposite outer surface of the anodized sheet of expanded aluminum foil.

21. The composite structure of claim 20, wherein the first resin system is in contact with the second resin system via perforations in the anodized sheet of expanded aluminum foil.

22. The composite structure of claim 20, wherein the first resin system is substantially similar to the second resin system.

23. The composite structure of claim 20, wherein the first and second resin systems each independently comprise an epoxy, a toughened epoxy, a cyanate ester, a polyimide, a bismaleimide (BMI), a polyester, a polypropylene, or a combination thereof.

24. The composite structure of claim 19, wherein the at least one additional layer comprises a surfacing film with or without fiber reinforcement, and the composite structure has a basis weight ranging from less than about 66 grams per square meter (gsm) to about 100 gsm.

25. The composite structure of claim 20, wherein the composite structure has a basis weight ranging from less than about 115 grams per square meter (gsm) to about 230 gsm.

26. An aircraft component comprising the composite structure of claim 20.

27. A method of providing lightning-strike protection to an article, said method comprising the steps of:
incorporating the composite structure of claim 20 into the article.

28. The method of claim 27, wherein the article comprises an aircraft.
